(19) United States
(12) Patent Application Publication
(10) Pub. No.: US 2026/0146779 A1
(43) Pub. Date: May 28, 2026

(54) COMPOSTABLE COLD PACK COMPRISING AN ABSORBANT SUBSTRATE LOADED WITH WATER

(71) Applicant: MICROTEK HOLDINGS, INC., Dayton, OH (US)

(72) Inventor: Richard M. FORMATO, Grafton, MA (US)

(73) Assignee: MICROTEK HOLDINGS, INC., Dayton, OH (US)

(21) Appl. No.: 19/401,697

(22) Filed: Nov. 26, 2025

Related U.S. Application Data
(60) Provisional application No. 63/725,952, filed on Nov. 27, 2024.

(51) Int. Cl. F25D 3/08; C08L 1/02; C08L 67/04; C09K 5/06

(52) U.S. Cl. CPC F25D 3/08; C08L 1/02; C08L 67/04; C09K 5/066; C08L 2201/06; C08L 2203/162

(57) ABSTRACT

Compostable cold packs have a compostable film sealingly enclosing a fill material. The fill material includes a compostable or biodegradable sponge contributing 1% to 10% weight solids to the fill material, at least 90% by weight water, and a biocide, with the sponge in an expanded state as a result of absorption of the water and biocide. The compostable film comprises (1) a cellulose based film that includes a sealant film comprised of either a) polybutylene adipate terephthalate (PBAT), b) polybutylene succinate (PBS), c) un-oriented polylactic acid (PLA), d) biaxially oriented PLA (BOPLA), or (e) a cellulose wood pulp and starch blend; (2) a BOPLA based film that includes an inner sealant film comprised of either a) polybutylene adipate terephthalate (PBAT), b) polybutylene succinate (PBS), or c) un-oriented polylactic acid (PLA); or (3) a single film of heat sealable BOPLA. Methods of making the cold packs are also disclosed.

### RELATED APPLICATIONS

This application claims the benefit of U.S. Provisional Application No. 63/725,952, filed Nov. 27, 2024, the entirety of which is incorporated herein by reference.

### TECHNICAL FIELD

The present application relates to a shape-stable, compostable and/or biodegradable thermal cold pack, more particularly, to a cold pack having an industrially and/or home compostable film enclosing a compostable and/or biodegradable sponge in an expanded state saturated with water which is treated with a biocide.

### BACKGROUND

Phase change materials (PCMs) have been utilized as thermal energy storage systems for decades due to their ability to store and release energy in the form of heat during a phase transition, most commonly from the solid to liquid states. PCMs exist in many forms including organic, inorganic, eutectics, and solid-solid. With this wide variety, a range of (phase change) temperatures for different applications can be achieved. It is important to have a PCM phase change temperature in a workable range for the application in order to get the full charge of energy out of (or into) the system.

A commonly known application of energy storage is in the form of cold pack therapy. Cold packs come in two common types: instant cold packs, which are chemical reaction based products, or reusable cold packs that typically have a thermal mass that requires freezing before use. Some reusable cold packs are generally water based formulations that once active, keep their surroundings cold for a specified amount of time. They are commonly used as first aid relief, and food and beverage controlled refrigeration.

Water is one of the best known PCMs due to its high latent heat value of 334 J/g, but water also has disadvantages. Water melts around 0° C., however, it can be super cooled to temperatures on the order of −40° C. Most commercial freezers only reach temperatures in the −23° C. to −15° C. range, which presents a problem for a water based formulation that requires freeze temperatures lower than that to charge the PCM completely.

While there are commercial products that base their phase change on the presence of water, its efficacy is often diluted by the other additives needed to improve the formula in other areas, like viscosity, and freeze temperature. Others add gellants or thickeners to form a gel. Not only will these additives dilute the enthalpy available of the water, therefore hindering its efficacy as a PCM, but they also make manufacturing a consistent product much more difficult, mainly due to inconsistencies in the making (mixing) of the formulation, as well as conveying and dispensing the mixture into its packaging (flexible and/or rigid).

Furthermore, companies have a need for cold chain solutions that support their sustainability goals. Pelton Shepherd, for example, recently launched TERRA ICE™ (v2.0) which claims to be the first 100% compostable gel ice pack designed for environmentally responsible shipping practices. Both the gel and the film are certified compostable in municipal or industrial facilities per ASTM D6400. Minus Works introduced a new refrigerant gel formulation that features a biodegradable, plant-based gel that is semi-solid and will not leak or flow if the (flexible) containment film is broken or punctured, and it is used to protect perishables at frozen or refrigerated temperatures (applications include meal kits, online grocery, specialty food delivery, heat sensitive healthcare products, biopharma, and thermosetting chemicals). The product is claimed to be a sustainable alternative to “foam” freezer bricks, made with open cell phenolic (floral) foam, which is a not compostable, and is a pollutant.

Gel packs, including those discussed above, are used in thermal shipping systems and are susceptible to gravity and deformation during shipping. A high performing thermal shipping system would be one that utilizes a shape stable refrigerants, fill, or other internal material that not only freezes flat, but also has uniform dimensions (especially thickness), which is critical to protecting the edges and corners of the product (load) being shipped. As part of the thermal shipping system, the cold pack must also be able to perform in any orientation (especially when the largest dimension is in the direction of gravity). As such, a need exists for higher performing, fully (home) compostable water based cold packs. This simplified water-based cold pack must avoid the use of unnecessary additional chemicals or additives, be constructed of commercially available off the shelf components, which are adaptable to existing manufacturing methods/machinery and have a useful shelf life (e.g., retain their mass when held at ambient conditions for a minimum of 6 months).

### SUMMARY

In a first aspect, compostable cold packs that have a compostable film sealingly enclosing a fill material are described herein. The fill material includes a compostable or biodegradable sponge contributing 1% to 10% weight solids to the fill material, at least 90% by weight water, and a biocide, with the compostable or biodegradable sponge in an expanded state as a result of absorption of the water and biocide. In all embodiments, the fill material does not form a gel. The compostable film is likely one of the following (1) a cellulose based film that includes a sealant film comprised of either a) polybutylene adipate terephthalate (PBAT), b) polybutylene succinate (PBS), c) un-oriented polylactic acid (PLA), d) biaxially oriented PLA (BOPLA), or (e) a cellulose wood pulp and starch blend; (2) a BOPLA based film that includes an inner sealant film comprised of either a) polybutylene adipate terephthalate (PBAT), b) polybutylene succinate (PBS), or c) un-oriented polylactic acid (PLA); or (3) a single film of heat sealable BOPLA.

In some embodiments, the compostable films (1), (2), and (3) include a barrier layer. The barrier layer may include aluminum, such as an aluminum metalized barrier layer or an inorganic aluminum oxide barrier layer. In some embodiments, the compostable film is an industrially compostable film or a home compostable film. In some embodiments, the compostable film has a cellulose based film that includes a sealant film comprised of polybutylene succinate. In other embodiments, the compostable film has a cellulose based film that includes a sealant film comprising a mixture of cellulose wood pulp and starch.

In all embodiments, the sponge can be a cellulose sponge. The percent weight of solids noted above can be equivalent to the % weight of the cellulose sponge. In all or some embodiments, one or more corners of the dry, compressed sponge are trimmed at an angle relative to the neighboring top seal and/or bottom seal. In all or some embodiments, the dry, compressed sponge has a horizontal and vertical uptake of at least 10 g/g.

In all embodiments, the biocide can be selected from the group consisting of 3-iodo-2-propynyl-butylcarbamate; 5-chloro-2-methyl-4-isothiazolin-3-one; 2-methyl-4-isothiazolin-3-one; 1,2-benzisothiazolin-3-one; 2-bromo-2-nitro-1,3-propanediol, and combinations thereof. In one embodiment, the biocide includes 3-iodo-2-propynyl-butylcarbamate. In another embodiment, the biocide includes a mixture of 5-chloro-2-methyl-4-isothiazolin-3-one, 2-methyl-4-isothiazolin-3-one, and 1,2-benzisothiazolin-3-one.

In some embodiments, the fill material is a cellulose sponge with only water and a biocide.

In all embodiments, the cold pack is configured to be received in a cold chain shipping container. The cold pack can have a water vapor transmission rate at 22° C., 36% relative humidity through the compostable film in a range of 0.05 to 0.11 g/100 in²/day.

In a second aspect, methods of making such compostable cold packs are disclosed herein. The method includes feeding a three-sided pouch having an open end that is made of a compostable film into an in-line vertical pouch machine; inserting a dry, compressed compostable or biodegradable sponge into the three-sided pouch; dispensing an aliquot of water into three-sided pouch; and sealing the open end with a fluidtight seal to produce a cold pack. The three-sided pouch and the dry-compressed sponge are preferably industrially and/or home compostable. The method can be completed in the order above or the dry, compressed sponge can be inserted into the pouch before the dispensing of the aliquot of water. The method can include feeding an industrially compostable film or a home compostable film into the in-line vertical pouch machine and forming the three-sided pouch as well. The methods can also include storing the cold pack in a frozen state. The options for the fill material and the compostable film are as summarized above and as described in detail below.

In a third aspect, methods of making a compostable cold pack includes feeding a compostable film from a roll stock into a horizontal flow wrapper machine; providing an expanded cellulose sponge having absorbed therein water or water treated with a biocide; wrapping the compostable film around the expanded cellulose sponge; and sealing the compostable film to enclose the expanded cellulose sponge in a fluidtight, compostable film package. In other embodiments, the method can include providing a dry, compressed cellulose sponge; contacting the dry, compressed cellulose sponge with the water or the water treated with a biocide to form the expanded cellulose sponge. The method can also include removing one or more corners of the dry, compressed cellulose sponge before or after contacting the dry, compressed cellulose sponge with water. The corners are each trimmed at an angle relative to a neighboring top end and/or bottom end of the sponge. The options for the fill material and the compostable film are as summarized above and as described in detail below.

### BRIEF DESCRIPTION OF THE DRAWINGS

FIG. 1 is a photograph of a first embodiment of a water-based cold pack.

FIG. 2 is a photograph of a second embodiment of a water-based cold pack.

FIG. 3 is a top view photograph of the first embodiment before the addition of the water and formation of the top seal.

FIG. 4 is a top view photograph of the first embodiment after the addition of water before the top seal is formed

FIG. 5 is a top view photograph of the second embodiment after the addition of water before the top seal is formed.

FIG. 6 is a back view of a third embodiment of sealed cold pack made using a horizontal flow wrapper machine.

FIG. 7 is a chart of sponge uptake data for cellulose sponges of different thicknesses.

FIG. 8 is an exploded view of the layers of an industrially compostable film available from Eagle Flexible Packaging, a US Company.

FIG. 9 is an exploded view of the layers of a home compostable film available from RooTree, a Canadian Company.

FIG. 10A is a graph of percent weight change versus time (weeks) for cold packs made with both Eagle and RooTree brand films shown in FIGS. 7 and 8.

FIG. 10B is a chart of data comparing the water vapor transmission rate (WVTR) of cold packs made with the Eagle and RooTree Brand films shown in FIGS. 7 and 8.

FIG. 11 is a chart of data from a box study summarizing the % relative humidity and temperature over time inside various boxes filled with cold packs of the present invention.

FIG. 12 is a graph of % loss of the cold packs during the 26 week box study.

FIG. 13 is a photograph of a cold chain thermal shipping container (Styrofoam) loaded with N=10 cold packs disclosed herein.

### DETAILED DESCRIPTION

The following detailed description will illustrate the general principles of the invention, examples of which are additionally illustrated in the working and comparative examples.

As used herein, “biodegradable” means any material that can be broken down by microorganisms (such as bacteria and fungi) and assimilated into the natural environment. Unless otherwise noted, no specific environmental exposure conditions and/or degradation rates are assumed.

As used herein, “compostable” means a product or material that can biodegrade under specific, human-driven circumstances (typically, temperature, humidity, time, etc.). There are agencies that certify products or individual components of products as compostable, more specifically as industrially compostable (also known as aerobic biodegradable), in accordance with ASTM D6400 and D6868 protocols or as anaerobically digestible in accordance with ASTM D5511 testing protocols. These agencies include but are not limited to: Biodegradable Products Institute (BPI), Compost Manufacturing Alliance (CMA), TuV Austria, Din Certco, and the Compost Council of Canada.

All numerical values set forth herein can be modified by the word “about” whether expressly stated or not. “About” as used herein means plus or minus 5% of a numerical value, or more preferably plus or minus 2%. For ranges, the minimum and maximum values are included in the range and all values therebetween. It is further understood that the endpoints of each range are significant both in relation to the other endpoint, and independently of the other endpoint. Percentages for concentrations are typically % by weight/weight unless expressly stated otherwise. “Substantially free” means 1% wt/wt or 0.5% wt/wt, or more preferably 0.01% wt/wt or less are present of the identified substance.

The term “ambient conditions” as used herein refers to surrounding conditions under about one atmosphere of pressure, at about 50% relative humidity, and at about 22° C., unless otherwise specified. All values, amounts, and measurements described herein are obtained under ambient conditions unless otherwise specified.

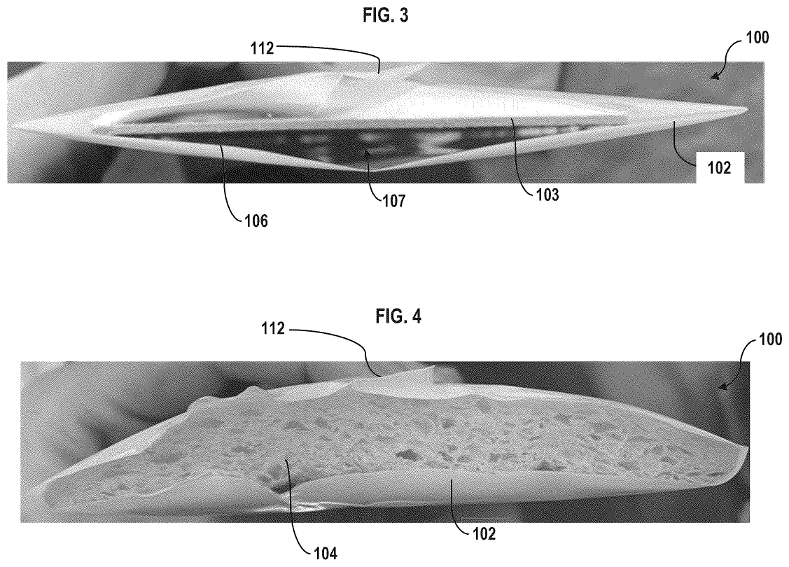

Referring to FIGS. 1, 3, and 4, a first embodiment for a home and/or industrially compostable or biodegradable cold pack 100 is disclosed. The cold pack 100 is made of an industrially and/or home compostable film 102 formed into a receptacle 107 configured to receive a compressed, dry cellulose sponge 103, as shown in FIG. 3, and water. The industrially and/or home compostable film 102 can start as a sheet or roll of film that has elongate free ends mated and sealed to form an elongate seal 112 and a generally tubular structure. The tubular structure then has a bottom seal 108 formed transverse to the elongate seal 112 to form a fluid-tight, sealed, closed end. The tubular structure is then cut transverse to the elongate seal 112 a preselected distance D from the bottom seal 108 to define an open end 106 and the receptacle or cavity 107. The compressed, dry cellulose sponge 103 is seated in the receptacle 107, water or water treated with a biocide is introduced therein for uptake by the sponge 103 to yield an expanded cellulose sponge 104 as seen in FIGS. 1 and 4. Next, the open end 106 is sealingly closed, thereby defining a top seal 110 that is fluid-tight. The cold pack 100 may have a top flange 107 of industrially and/or home compostable films 102 extending away from the top seal 110 and away from the expanded sponge 104.

In another embodiment, the industrially and/or home compostable film can start as a sheet or roll of film which is fed into a horizontal flow wrapper machine (for example an Ilapak Delta 3000 LD). The compressed, dry cellulose sponge 103 is contacted with water or water treated with a biocide to yield an expanded cellulose sponge 104. The amount of water to be introduced is controlled such that the water weight (when compared with the total weight of the sponge+water) is in the range of 90% to 98% of the total, ideally within 90% to 95% of the total. Referring to FIG. 6, the expanded cellulose sponge 104 enters the horizontal flow wrapper, such that the sheet or roll of film 102 wraps around the expanded cellulose sponge, which results in a tubular structure having an elongate seal 112 and two open ends 106, 106′, which are subsequently sealingly closed, defining a fluidtight top seal 110 and a fluidtight bottom seal 110′. The top seal 110 and bottom seal 110′ are shown as dashed areas, the area of which (typically based on the width W of the seal) can be set as needed for durability of this cold pack 101.

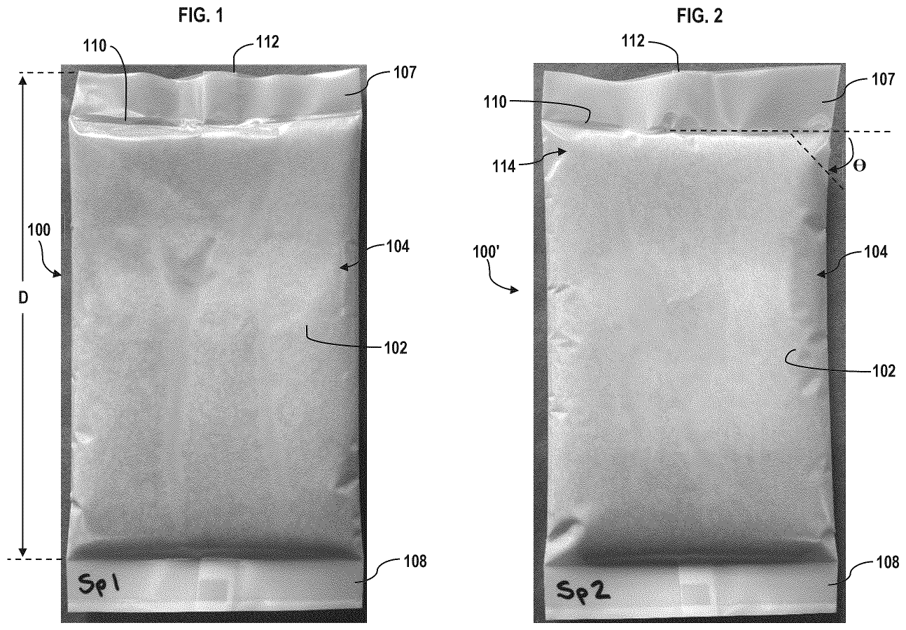

In another embodiment, the industrially and/or home compostable film 102 can be provided as a 3-sided pre-formed pouch having one open end ready for the compressed, dry sponge 103 to be inserted therein. This operation can be completed on an “in line vertical pouch” type of machine (for example SchurStar 2060), which can accept already formed 3-sided pouches and/or form pouches in situ, followed by the insertion of the pre-compressed dry cellulose sponge 103 (e.g., via card feeder or equivalent) followed by dispensing of the desired amount/type of water, followed by sealing of the one originally open ends 106 to define a fluidtight sealed end, such as top seal 110 shown in FIGS. 1 and 2.

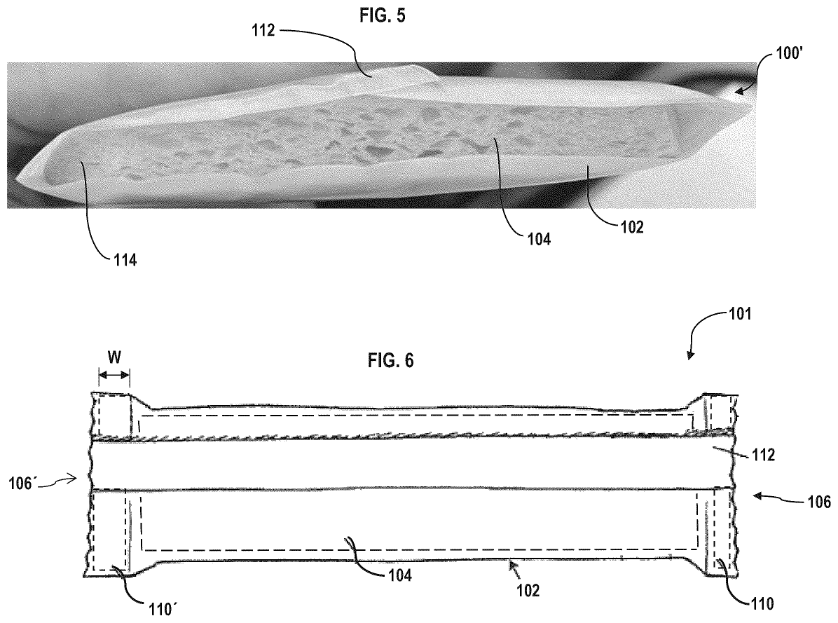

Referring now to FIGS. 2 and 5, a second embodiment for a compostable or biodegradable cold pack 100′ is disclosed. The cold pack is made of a home and/or industrially compostable film 102 formed into a receptacle 107 configured to receive a compressed, dry sponge and water. The sponge in this embodiment has a generally rectangular shape, however, the four corners have been trimmed off at an angle θ relative to the neighboring top seal 110 and/or bottom seal 108. Angle θ can be in a range of 1° to 89°, more preferably 5° to 75°, and even more preferably 10° to 55°. In another embodiment, the sponge can be generally oval-shaped.

The cold packs 100, 100′ are intended to be sold for use as thermal refrigerants (insulating devices) for shipping containers such as cardboard boxes, Styrofoam containers, coolers, etc. An example of a Styrofoam shipping container holding ten cold packs 100 is shown in FIG. 13. The shipping container 200 defines an internal cavity 202 shaped to receive a payload in need of thermal management during transport. The shipping container 200 has a bottom 208 and four sides 210. The upper surface 212 of the sides 210 is configured with a continuous recess 214 configured for mating with an appropriately sized and shaped protrusive flange of a lid (not shown). Each of the four sides 210 and the bottom 208 define an open receptacle 216, 218 respectively, which are each shaped to receive one or more of the cold packs 100 therein. The most interior surfaces of the cold packs 100 collectively define the bounds of the cavity 202 space for the payload.

### Sponge

Cellulose sponges were selected because they are biodegradable and/or compostable and can meet other parameters considered for this end product. The goal is to have a low cost, superwetting material that can uptake a non-polar (n-alkane) or a polar (water) liquid, such as by capillary action, will not chemically react with the liquid, will retain the liquid after uptake, is highly porous (90% or greater porosity and/or uptake of the liquid), is thermally stable up to at least 150° C., has a low density, is available in desired dimensions (e.g., 24″×24″×(0.25″ to 2.00″) thick in at least 0.25″ increments), with excellent dimensional tolerance (+/−⅛″ desired, ideally +/− 1/16″), consistent batch to batch properties, and compatible with typical packaging manufacturing machinery. Prior to cellulose sponges, particulate materials (size less than 20 microns) were explored as well as cotton fiber mats, but none of these meet all the parameters listed above. Cellulose sponges are made primarily from plant pulp, such as wood pulp. The cellulose sponge is free of magnesium chloride and is certified “green” in accordance with ISO 14001-2004.

Compressed cellulose sponges were purchased in large sheets (up to 34″×34″ in size) and were cut to desired end use sizes. The cellulose sponge sheets were made by a reputable manufacturer, such as 3M, that provides products having generally consistent characteristics from batch to batch. The compressed cellulose sheets were available in a plurality of (wet: expanded) thicknesses (from 0.25″ to 1.50″), from which three were selected for evaluation, ½ inch, ⅝ inch, and 1 inch.

### Water Uptake Evaluation

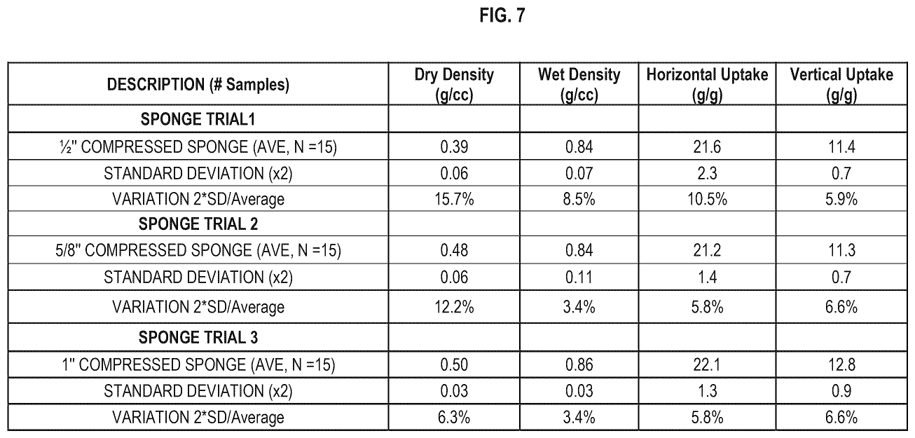

For each of the three sponge thicknesses, sponge samples having dimensions of 3.75×5 inches were cut from the sheets for a total of 15 of each thickness. Each sponge was weighed and then placed onto a hydrophobic mesh screen in a horizontal orientation and lowered into a flat pan of water for 30 seconds, the pan being filled to 75% of the sponge's expanded thickness. For example, a 1.0 inch sponge was placed in a pan with 0.75 inch depth of water. After the 30 seconds, the mesh screen with the sponge thereon was lifted vertically upward (and held steadily horizontal) out of the water and allowed to drain for 30 seconds. The expanded sponge was weighed and dimensions measured (weight was used to calculate the horizontal uptake value). Next, each sponge was placed in a vertical orientation on a rack for an additional 30 seconds and reweighed. This second vertical weight was used to calculate the vertical uptake value. The data from the evaluation are presented in FIG. 7. The “wet density” of each sponge (average=0.85 g/cc) is consistent regardless of the thickness of the sponge. The horizontal uptake and vertical uptake were similar, generally within a factor of 2 of each other. More specifically, in the horizontal orientation an uptake value of 20 g/g was calculated (which implies that a sponge can be loaded with 95% water to 5% sponge by weight in its horizontal orientation, without losing any water). Similarly, in the vertical orientation, an uptake value of 10 g/g was calculated (which implies that the sponge can be loaded with 90% water to 10% sponge by weight in its vertical orientation, without losing any water). A 9:1 water:sponge loading is preferred if the cold pack will be placed in non-horizontal configurations during use, which is typical for use in thermal shipping systems (see FIG. 13).

Tests were conducted on the cellulose sponges to evaluate whether they present a surface upon which bacteria will grow. Unlike the water filled pouches alone, tests showed no signs of bacterial/mold growth on the cellulose sponges, even without the use of a biocide.

### Biocide Treated Water

The water can be tap water, filtered water, deionized water, or the like. A biocide is added to the water to provide extended shelf life to the cold pack. The biocide can be selected from the group consisting of 3-iodo-2-propynyl-butylcarbamate; 5-chloro-2-methyl-4-isothiazolin-3-one; 2-methyl-4-isothiazolin-3-one; 1,2-benzisothiazolin-3-one; 2-bromo-2-nitro-1,3-propanediol, and combinations thereof. In one embodiment, the biocide is a mixture of 5-chloro-2-methyl-4-isothiazolin-3-one (1%), 2-methyl-4-isothiazolin-3-one (5%) and 1,2-benzisothiazolin-3-one (10%) available under the brand ACTICIDE® CBM 2 by Thor, which controls the growth of bacteria and fungi. In some embodiments, the biocide includes up to about 7% KOH. In one embodiment, the biocide is a mixture of methyl paraben and sodium benzoate. In one embodiment, the biocide is a mixture of glutaraldehyde and methanol.

Depending on the biocide used, recommended loadings may be as high as 0.30% wt. Ideally the biocide is present in the water at less than 0.10% by weight relative to the weight of the water and sponge collectively. The biocide can be present in a range of 0.001% to 0.09% wt/wt, more preferably 0.04% to 0.09% wt/wt thereof.

No gel is formed herein; the water stays as water. As such, the water is free of thickeners or other viscosity modifying agents.

### Film

The film for packaging the cellulose sponge and water treated with a biocide must be compatible with water and be certified as industrial and/or home compostable, or biodegradable. These are also described as flexible films. Film suppliers consistently indicated that the compostable/biodegradable films are NOT to be used with liquids and were only for room temperature (ambient condition) storage of products. For example, the Rootree™ brand film expressly states in its product literature that the film is not for chemicals, liquids, refrigerated or frozen products. After testing numerous compostable/biodegradable films, the results were films that have one of the following film constructions:
(1) a cellulose based film that includes a sealant film comprised of either a) polybutylene adipate terephthalate (PBAT), b) polybutylene succinate (PBS), c) un-oriented polylactic acid (PLA), d) biaxially oriented PLA (BOPLA); or e) wood pulp cellulose, starch, and mixtures thereof.
(2) a BOPLA based film that includes an inner sealant film comprised of either a) polybutylene adipate terephthalate, b) polybutylene succinate, c) un-oriented polylactic acid (PLA), or d) wood pulp cellulose, starch, and mixtures thereof; or
(3) a single film of heat sealable BOPLA.
   The films tested are shown in Table 1 below under the section heading “Flexible Film Evaluation”.

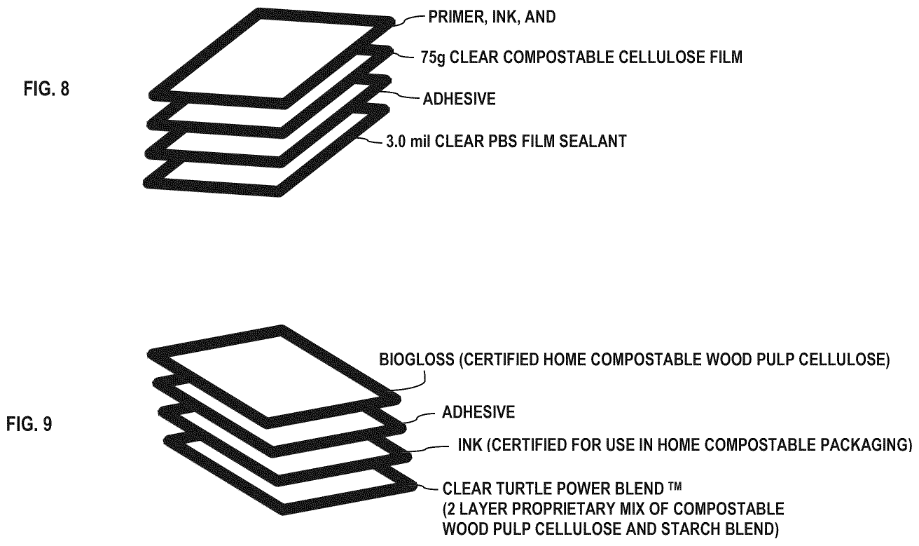

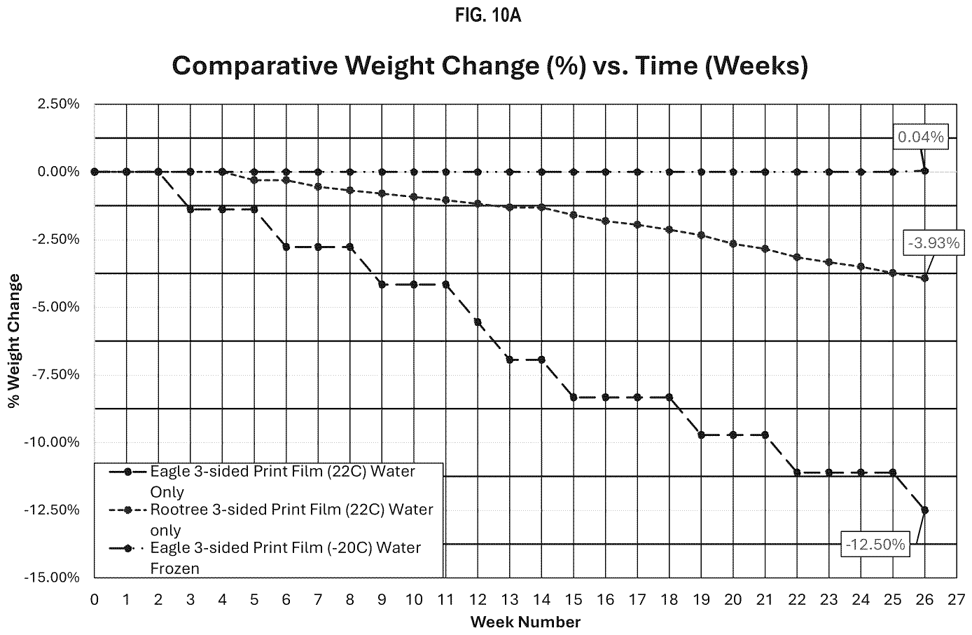

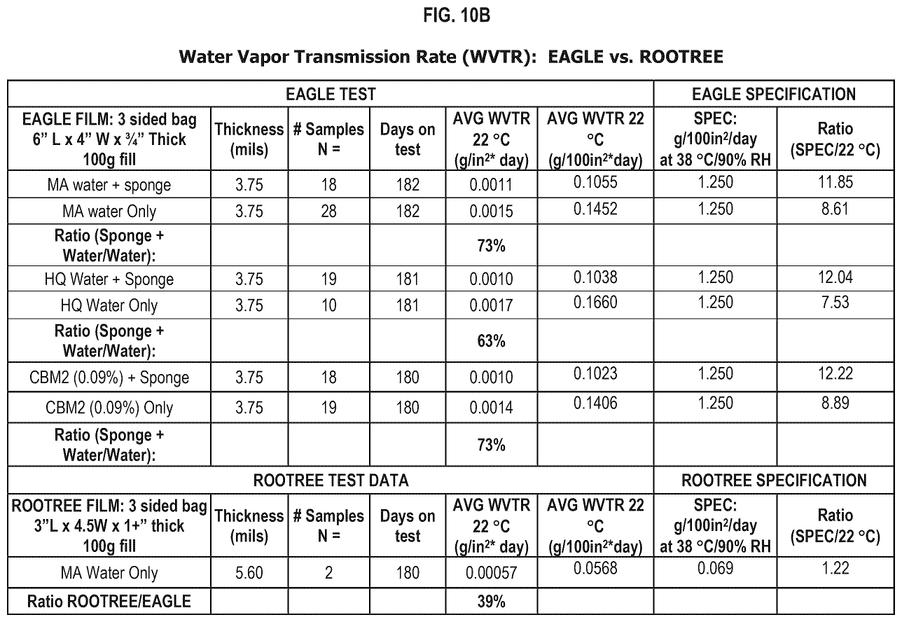

When the film comprises a cellulose based film, the cellulose film is at least a 75 gauge (g), or 0.75 mil cellulose layer. In some embodiments, the cellulose based film is a 75 g film. In other embodiments, it is a 90 g film. Eagle brand film, in one embodiment, has a 75 g layer of clear cellulose based film, more specifically Natureflex NKA from Futamura, adhered to a layer of 3.0 mil clear Polykar PBS sealant. Each film layer is compliant with ASTM D6400 for industrial compostability (the adhesive and inks are pending certification). The structure of this film is illustrated in FIG. 8. This film had a % weight change of −12.50% over 26 weeks as shown in FIG. 10A for the “layflat” pouch test explained in Working Example 1 below. Testing of the Eagle brand film indicated that the shelf life could be extended, almost indefinitely, if the cold packs were stored frozen (no measurable loss noted at either 26 weeks as shown in FIG. 10A (further testing showed the same results after 52 weeks).

In another embodiment, the film can be a Rootree brand compostable film and/or home compostable film, certified to be made of 98% home compostable materials. The selected film can have a cellulose film layer and a second, inner film layer that is a proprietary mix of cellulose wood pulp and starch, see FIG. 9. This film had a % weight change of −3.9% over 26 weeks as shown in FIG. 10A for the “layflat” pouch test explained in Working Example 1 below. This film also had suitable results from the autopsy performed on the film at the end of the box test. RooTree film had the best overall test results, which was surprising since the manufacturer expressly states in its literature that the film is not for use with liquids nor is it for use with either refrigerated or frozen products.

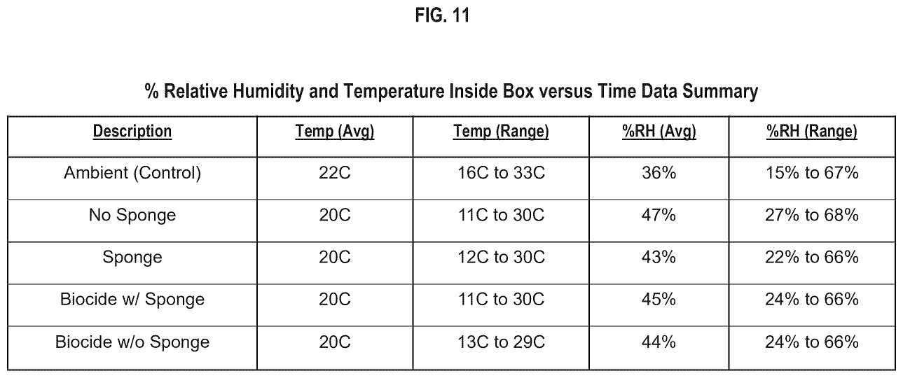

A comparison of water vapor transmission rate (WVTR) for the Eagle film versus the RooTree film, is shown in FIG. 10B. In FIG. 10B, MA water is water from the tap in Leominster, Massachusetts and HQ is water from the tap at headquarters in Dayton Ohio. As is noted in the figure, the average WVTR for Eagle water only filled samples, at ambient conditions (22° C., 36% RH, as per FIG. 11) ranged from 0.141 to 0.166 g/100 in²/day (Eagle specification=1.25 g/100 in²/day at 38° C./90% RH), a ratio of 7.53x to 8.89x. These same samples, including a sponge (22° C., 36% RH) were very consistent ranging from 0.102 to 0.106 g/100 in²/day, which was measurably lower (63% to 73% of the water only filled samples) than the water only samples. The data clearly shows that addition of the sponges resulted in more consistent performance, at a lower WVTR.

Somewhat surprising was the average WVTR for RooTree water only filled samples, at ambient conditions (22° C., 36% RH), which averaged 0.057 g/100 in²/day. The RooTree specification=0.069 g/100 in²/day at 38° C./90% RH), which is a ratio of only 1.22x. Although the RooTree film sample is thicker (5.6 mils) than the Eagle film sample (3.8 mils), this alone does not explain the RooTree film's significant (relative) decrease in WVTR.

The films are available in a plurality of thickness. Films having a thickness of about 1.0 mil to about 8.0 mils, more preferably about 2.0 mils to about 6.0 mils are suitable for cold pack applications. The RooTree brand film discussed above is available as a 5.6 mil thick film with instructions to store indoors (out of the sun) at 15-24° C. and at 30-50% relative humidity.

The cold packs disclosed herein are designed to meet a plurality of parameters, including but not limited to, shelf stability, seal robustness, leak resistant, compostability, water resistant film, thermal performance, syneresis, and cost. Shelf stability is measured based on having less than 10% weight change after exposure to room temperature for 6 months while laying flat or while in a box and no biological growth in the contents. Seal robustness is evaluated via a burst test with a 95% pass rate. Leak resistance threshold is a maximum leak rate of 2% (ideally <1%) after shipping). The film cannot have a layer, such as an adhesive or ink layer that is compromised by exposure to water. A latent heat value that is at least 90% that of the water for the cold pack as a whole is acceptable. It is desirable that the cold pack have a syneresis of less than 5% at 24 freeze/thaw cycles and/or when the cold pack is oriented vertically during use (this syneresis level is consistent with standard phenolic foam water bricks currently used in thermal shipping systems).

### Flexible Film Evaluation

Evaluation of compostable film candidates was conducted by forming a cold pack structure, filling it with a phase change material, sealing the cold pack closed, and setting to soak at 40° C. Each cold pack was evaluated weekly for leakage through the film or at the seals.

TABLE 1
40 C. Soak Test

| Trial | | | Thickness | |
|---|---|---|---|---|
| # | Manufacturer | Film Construction | (μm) | Results |
| 1 | TIPA | PBSA/PLA | 80 | Fail at week 1 (permeation |
| | | | | through the film) |
| 2 | Biax LLC | PLA Seal/PLA/PLA Seal | 75 | Trial A failed after week 24 at |
| | | | | the seal |
| | | | | Trial B failed after 16 weeks |
| 3 | Biax LLC | S. Treated PLA/PLA Seal | 75 | Fail after 17 weeks |
| 4 | Eagle+ | 80 g PLA blown film/120 | 50 | Fail after 11 weeks |
| | | g MET BOPLA | | |
| 5 | RooTree | PLA blown film/BOPLA | 40 | Fail after 11 weeks |
| 6 | ABGAR | 75EVHS1 BOPLA | 75 | Fail after 24 weeks |
| 7 | Technicote | 50 μm PLA blown film | 50 | Fail after 1 week (permeation) |
| | | sealant | | |
| 8 | Genpack | 75 g NKR/50 μm PLA | 70 | Passed through week 32 |
| | | blown film | | |
| 9 | RTG | 30 μm BOPLA | 30 | Fail after 9 weeks |
| 10 | Excellent | Cellulose only | | Fail at week 1 (seal) |
| | Pkg | | | |
| 11 | Eagle | Cellulose/Polykar PBS | | Trial A - fail after 18 weeks |
| | | | | Trial B - fail after 17 weeks |
| 12 | Bryce | 90 g cellulose/WBA/90 g | 45 | Film would not seal. |
| | | MET cellulose | | |
| 13 | Bryce | 90 g cellulose/WBA/80 g | 43 | Fail after week 26 |
| | | MET PLA | | |
| 14 | Bryce | 160 g BOPLA/WBA/120 | 70 | Fail after 15 weeks |
| | | g PLA | | |
| 15 | Eagle | PBS sealant only | 75 | Fail after 1 week |
| 16 | Bryce | 90 g cellulose/WBA/80 g | 43 | Passed through 24 weeks |
| | | AlOx PLA | | |
| 17 | RooTree | 75 g cellulose/Adh/38 | 60 | Passed through 22 weeks |
| | | μm PBS | | |
| 18 | Genpack | 2.5 mil ECOFLEX ™ | 63 | Fail after 1 week (permeation) |
| | | PBAT | | |

*Adh = adhesive; WBA = water based adhesive; MET = metallized film/substrate;

Those films passing the test through at least 13 weeks became a candidate for further evaluation (i.e., Trials 2-3, 6, 8, 11, 13-14, and 16-17). The films from trials 8, 11, 16 and 17, were selected for additional testing. The film roll stock can be processed into the cold pack using a 3 sided bag making machine, a flow wrapper machine, or a vertical form filling machine.

### WORKING EXAMPLE 1

The Eagle Brand flexible film, having a 75 g cellulose layer and a 3 mil Polykar PBS inner (sealant) layer, and the RooTree brand film, 5.6 mils thick, having a cellulose film layer and a second, inner film layer that is a proprietary mix of cellulose wood pulp and starch, (sealant) layer, were tested. The films were folded and sealed, except for a top seam, to define a cold pack package having an internal cavity that is approximately 4 inches by 6 inches. Some of the cold pack packages were filled with deionized water, some with deionized water treated with a biocide, some with a dry compressed sponge and deionized water, and some with a dry compressed sponge, deionized water and a biocide. Once filled the films were sealed closed to complete the cold pack. The pre-compressed, dry sponge is a ⅝″ thick (expanded) cellulose sponge, the biocide was ACTICIDE® CBM 2 and the fill is as identified below:

The fill material when the sponge was present was based on the % wt/wt presented in Table 2 below.

TABLE 2
Fill material

| Name | Function | % wt/wt |
|---|---|---|
| Sponge | Solids | 10% |
| Water | PCM | 89.91% |
| ACTICIDE ® CBM 2 biocide | Biocide | 0.09% |

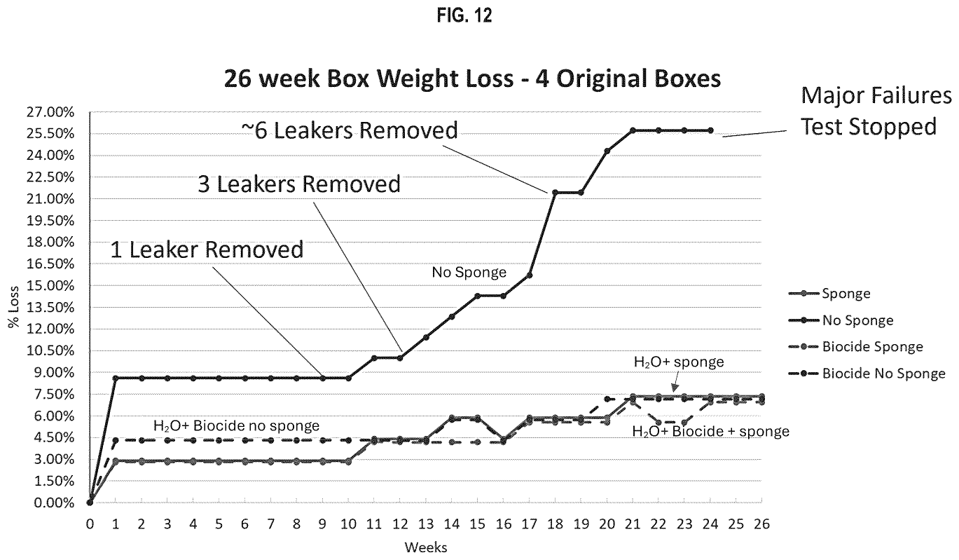

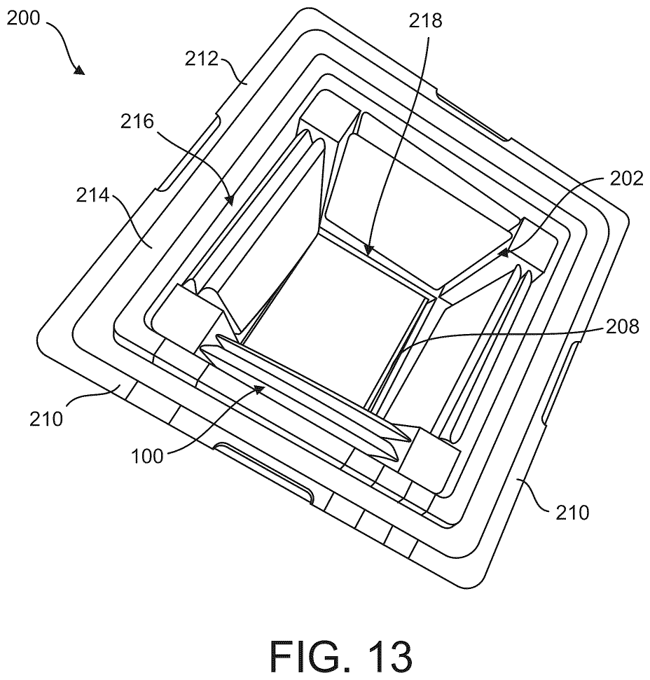

The cold packs were placed in corrugated cardboard boxes and stored at ambient conditions, lying flat, with a layer of corrugated cardboard between layers of cold packs. More specifically, the corrugated carboard boxes were 18″×9″×9″ boxes with single layer corrugate surrounding and between layers. The samples were placed in twelve layers consisting of alternating arrays of five samples for a total of 60 samples per box. A relative humidity (RH) and temperature sensor (Elitech) was placed inside each box to log % RH and temperature. A summary of that temperature and % RH data is shown in FIG. 11. The boxes of cold packs were each weighed at weekly intervals and the % weight change (decrease) was monitored over 26 weeks. The data is presented in graph form in FIG. 12. Unlike the water only (no-sponge samples), all samples that included a sponge survived the 26 week study without a major leak or catastrophic failure.

The above study was also completed with tap water from two different community water sources, with and without a sponge. For the samples with sponges, one had no biocide, a second had 0.20% wt ACTICIDE® CBM 2 biocide, and a third had 0.09% wt ACTICIDE® CBM 2 biocide mixed with 0.05% wt IPW40 carbamic acid, butyl-, 3-iodo-2-propynyl ester biocide (for each water source). During this secondary test, some of the cold packs that contained water only developed leaks. The leaks were sealed and the cold packs returned to the study. The leaks appeared at points where the films were wrinkled or crumbled, likely from handling during the study.

The presence of the cellulose sponges in the cold pack resulted in noticeably less weight loss over time. The presence of the biocide also helped mitigate weight loss over time. More specifically, the cold packs where the water included a biocide ended with the lowest % weight loss, as follows:
Sponge: Average % loss with biocide—7.7%
No Sponge: Average % loss with biocide—11.6%
   Further, all cold packs that included a sponge met the requirement of less than 10% weight loss over 26 weeks. There was no noticeable difference between the samples that have ACTICIDE® CBM 2 biocide only and those that include the IPW40 carbamic acid, butyl-, 3-iodo-2-propynyl ester biocide. Also, no bacterial or mold growth was present at the conclusion of the study.

At the conclusion of the study at 26 weeks, the cold packs (i.e., the films) were inspected and autopsied to check for delamination, bubbles in the film, etc. When the layers stacked in the box were separated by sheets of corrugated cardboard, the films were able to “breath” and no defects formed in the outer film layer.

The fact that the cold packs lost weight during the 26 weeks at room temperature, as evidenced by the increase in % relative humidity inside the boxes, see FIG. 11, confirmed that the films are water permeable. It evidenced that the sponge helped retain the water inside the cold pack, i.e., it had a lower relative humidity value than the cold packs that were filled with water only.

### Comparative Example

A foam brick water based refrigerant was selected for comparison, such as the RE-FREEZ—R-BRIX™, available from Fast Packaging. The cold pack was weighed, then the foam brick was carefully removed from its plastic packaging without deforming the foam brick. The brick was weighed, and its dimensions were measured. It was noted that free water was present inside the packaging once the brick was removed. The free water was measured to be about 5% by weight thereof. The brick was then heated in an oven set at 80° C. until a constant weight was achieved. The bricks were cooled, weighed, and their dimensions were measured. A pre-compressed cellulose sponge was cut to the average size of the brick. Then, the sponge was allowed to uptake water until fully reconstituted. Each expanded sponge was weighed and thereafter dried under the same conditions as the brick. Once dried, the sponge was cooled, dried and measured again.

Next the dried brick was cut to a reasonable product size, selected for this trial as 5 in×3¾ inch by 1 in. The dried sponge was cut to the same dimensions. Each was inserted into a film package made of the same film material, the Eagle 3-sided Print film, reconstituted with the same amount of water, and evaluated.

The following data was gathered regarding the brick and the sponge.

TABLE 3

| | Phenolic Foam Brick | | | Cellulose Sponge | | |
|---|---|---|---|---|---|---|
| Mean mass (wet) | 1652 g | | | 1609 g | | |
| Mean mass (dry) | 28 g | | | 85 g | | |
| | Length | Width | Height | Length | Width | Height |
| | (in) | (in) | (in) | (in) | (in) | (in) |
| Mean dimension (wet) | 11.25 | 9.25 | 1 | 12 3/16 | 10 | 1 |

| | | |
|---|---|---|
| Average water | 1624 g | 1557 g |
| % water | 98.3% | 94.8% |
| Uptake (Mass) | 57.5 g/g | 18.3 g/g |
| | brick | sponge |

The phenolic foam brick is weak to stress. It deforms easily, had no ductility, is rigid and brittle, and drying the brick reduced its subsequent uptake of liquid. The uptake was reduced to 60% of its original value. In contrast, the cellulose sponge is ductile, elastic, retains its form, and drying did not reduce its subsequent uptake of liquid.

It was observed that the foam brick, which was made of a phenolic material, deformed easily, had no ductility, was rigid and brittle, and the drying process at 80° C. reduced subsequent uptake of water by the brick by as much as 60% of its original value. The cellulose sponge was elastic, retains its form, and drying at 80° C. did not reduce its uptake characteristics (performed similarly to the cellulose sponge, as supplied; in theory this suggests that the sponge could be re-used). The phenolic foam brick weighed less than the sponge but held more water per gram than the cellulose sponge (57 g/g phenolic foam brick as compared to 20 g/g cellulose sponge), which equated to the 98.4% and 94.8% void volume (dry) reported in Table 3 above. Also, the RE-FREEZ—R-Brix™ had approximately 5% loose water surrounding the brick.

### Advantages

The cold packs use water and a biocide and solidify as temperatures fall below 0° C. (approx. 32° F.) and liquefy as temperatures rise above 0° C. (32° F.). The product's optimal operating range is −2° C. to 2° C. (28° F. to 36° F.). The cold packs can be stored in a cool, well-ventilated location. However, preferred storage is in the fully frozen (−20° C.) state, to minimize or eliminate weight loss, which is a critical property for refrigerants used in thermal packaging applications. If stored in a liquid state, refrigeration conditions of 2-8° C. is highly recommended. Storage at 22° C. (room temperature) is possible, but if used, must not exceed 6 months cumulatively. Product should not be exposed to temperatures at or above 40° C. If this is unavoidable, exposure to 40° C. can occur for up to 4 weeks cumulatively. The pH is neutral (about 7) for the fill material and the individual components (film, cellulose sponge, water) are industrially and/or home compostable and are certified as such. The cold pack can be for single use and then disposal or can be used a plurality of times before disposal for composting. Also, the cold pack is shape stable, freezes flat, and retains water in both horizontal and vertical orientations.

Having described the invention in detail and by reference to specific embodiments and examples, it will be apparent that numerous modifications and variations are possible without departing from the spirit of the invention as defined by the following claims.

1. A compostable cold pack comprising:
a compostable film sealingly enclosing a fill material comprising:
a compostable or biodegradable sponge contributing 1% to 10% weight solids to the fill material;
at least 90% by weight water; and
a biocide;
wherein the compostable or biodegradable sponge is in an expanded state as a result of absorption of the water and biocide;
wherein the compostable film comprises:
(1) a cellulose based film that includes a sealant film comprised of either a) polybutylene adipate terephthalate (PBAT), b) polybutylene succinate (PBS), c) un-oriented polylactic acid (PLA), d) biaxially oriented PLA (BOPLA), or (e) a cellulose wood pulp and starch blend;
(2) a BOPLA based film that includes an inner sealant film comprised of either a) polybutylene adipate terephthalate (PBAT), b) polybutylene succinate (PBS), or c) un-oriented polylactic acid (PLA); or
(3) a single film of heat sealable BOPLA;
wherein the fill material does not form a gel.

2. The compostable cold pack of claim 1, wherein the compostable film further comprises a barrier layer.

3. The compostable cold pack of claim 2, wherein the barrier layer comprises aluminum.

4. The compostable cold pack of claim 3, wherein the barrier layer comprises aluminum in the form of a metalized barrier layer or an inorganic aluminum oxide barrier layer.

5. The compostable cold pack of claim 1, wherein the compostable or biodegradable sponge is a cellulose sponge.

6. The compostable cold pack of claim 5, wherein the percent weight solids is equivalent to the % weight of the cellulose sponge.

7. The compostable cold pack of claim 1, wherein the compostable film is an industrially compostable film or a home compostable film.

8. The compostable cold pack of claim 1, wherein the compostable film comprises a cellulose based film that includes a sealant film comprised of polybutylene succinate.

9. The compostable cold pack of claim 1, wherein the compostable film comprises a cellulose based film that includes a sealant film comprising a mixture of cellulose wood pulp and starch.

10. The compostable cold pack of claim 1, wherein the biocide is selected from the group consisting of 3-iodo-2-propynyl-butylcarbamate; 5-chloro-2-methyl-4-isothiazolin-3-one; 2-methyl-4-isothiazolin-3-one; 1,2-benzisothiazolin-3-one; 2-bromo-2-nitro-1,3-propanediol, and combinations thereof.

11. (canceled)

12. The compostable cold pack of claim 1, wherein the biocide comprises a mixture of 5-chloro-2-methyl-4-isothiazolin-3-one, 2-methyl-4-isothiazolin-3-one, and 1,2-benzisothiazolin-3-one.

13. The compostable cold pack of claim 5, wherein the fill material consists of: the cellulose sponge, the water, and the biocide.

14. The compostable cold pack of claim 1, wherein the corners of the dry, compressed sponge are each trimmed at an angle relative to the neighboring top seal and/or bottom seal.

15. The compostable cold pack of claim 1, wherein the dry, compressed sponge has a horizontal and vertical uptake of at least 10 g/g.

16. The compostable cold pack of claim 1, wherein the cold pack has a water vapor transmission rate at 22° C., 36% relative humidity through the compostable film in a range of 0.05 to 0.11 g/100 in²/day.

17. The compostable cold pack of claim 1, wherein the cold pack is configured to be received in a cold chain shipping container.

18. A method of making a compostable cold pack comprising:
feeding a three-sided pouch having an open end that is made of a compostable film into an in-line vertical pouch machine;
inserting a dry, compressed compostable or biodegradable sponge into the three-sided pouch;
dispensing an aliquot of water into three-sided pouch; and
sealing the open end with a fluidtight seal to produce a cold pack;
wherein the three-sided pouch and the dry-compressed sponge are industrially and/or home compostable.

19. The method of claim 18, further comprising feeding an industrially or home compostable film into the in-line vertical pouch machine and forming a three-sided pouch.

20. (canceled)

21. The method of claim 18, wherein the dry, compressed sponge is inserted before the water.

22. (canceled)

23. The method of claim 18, further comprising removing the corners of the dry, compressed sponge, wherein the corners are each trimmed at an angle relative to a neighboring top seal and/or bottom seal.

24-28. (canceled)
